(19) United States
(12) Patent Application Publication
(10) Pub. No.: US 2023/0324914 A1
(43) Pub. Date: Oct. 12, 2023

(54) TRAVEL MAP GENERATION DEVICE, AUTONOMOUSLY TRAVELING ROBOT, TRAVEL CONTROL SYSTEM FOR AUTONOMOUSLY TRAVELING ROBOT, TRAVEL CONTROL METHOD FOR AUTONOMOUSLY TRAVELING ROBOT, AND RECORDING MEDIUM

(71) Applicant: Panasonic Intellectual Property Management Co., Ltd., Osaka (JP)

(72) Inventor: Hiroyuki MOTOYAMA, Osaka (JP)

(21) Appl. No.: 18/209,025

(22) Filed: Jun. 13, 2023

Related U.S. Application Data
(63) Continuation of application No. PCT/JP2021/039654, filed on Oct. 27, 2021.

(30) Foreign Application Priority Data
Dec. 25, 2020 (JP) 2020-216499

(51) Int. Cl. G05D 1/02; G01C 21/00; A47L 9/28

(52) U.S. Cl. CPC G05D 1/0214; G01C 21/383; A47L 9/2842; A47L 9/2847; A47L 9/2852; A47L 9/2805; A47L 2201/04; A47L 2201/06

(57) ABSTRACT

A travel map generation device includes: a sensor that obtains a positional relationship between the travel map generation device and an object in a vicinity thereof and processing circuitry (a controller). The processing circuitry (the controller): calculates, based on the positional relationship, a self position on a floor map representing a predetermined floor; obtains an image including reflected light produced by light emitted from a light emission device operated by a user; and generates, based on the self position and the image, information indicating an entry prohibited area into which an autonomously traveling robot is prohibited from entering, or a travel area for the autonomously traveling robot, in the floor map.

### CROSS REFERENCE TO RELATED APPLICATIONS

This is a continuation application of PCT International Application No. PCT/JP2021/039654 filed on Oct. 27, 2021, designating the United States of America, which is based on and claims priority of Japanese Patent Application No. 2020-216499 filed on Dec. 25, 2020. The entire disclosures of the above-identified applications, including the specifications, drawings and claims are incorporated herein by reference in their entirety.

### FIELD

The present disclosure relates to a travel map generation device, an autonomously traveling robot, a travel control system for an autonomously traveling robot, a travel control method for an autonomously traveling robot, and a recording medium.

### BACKGROUND

For example, PTL 1 discloses a method in which a marker indicating the presence of a restricted region, in which the free movement of an autonomously-moving body is restricted, is placed or affixed in a region in which the autonomously-moving body travels, and in which the movement of the autonomously-moving body is controlled based on a result of the autonomously-moving body detecting an optical marker.

### CITATION LIST

### Patent Literature

PTL 1: Japanese Unexamined Patent Application Publication No. 2019-046372

### SUMMARY

### Technical Problem

However, with the technique described in PTL 1, it is necessary to install or attach an optical marker in advance in a region in which the autonomously-moving body moves, which makes it difficult to easily set the restricted region.

Accordingly, the present disclosure provides a travel map generation device and the like capable of easily setting an entry prohibited area, into which an autonomously traveling robot is prohibited from entering, in a travel map for the autonomously traveling robot.

### Solution to Problem

To achieve the above-described object, a travel map generation device according to one aspect of the present disclosure is a travel map generation device that generates a travel map for an autonomously traveling robot that travels autonomously over a predetermined floor. The travel map generation device includes: a sensor that detects an object in a vicinity of the travel map generation device and obtains a positional relationship between the travel map generation device and the object; and processing circuitry. The processing circuitry is configured to: calculate, based on the positional relationship, a self position on a floor map representing the predetermined floor; obtain an image including reflected light produced by light emitted from a light emission device operated by a user; and generate, based on the self position and the image, information indicating an entry prohibited area into which the autonomously traveling robot is prohibited from entering, or a travel area for the autonomously traveling robot, in the floor map.

Additionally, an autonomously traveling robot according to one aspect of the present disclosure is an autonomously traveling robot that travels autonomously over a predetermined floor. The autonomously traveling robot includes: a main body; a travel mechanism that is disposed in the main body and that enables the main body to travel; a position sensor that detects a position of an object in a vicinity of the main body and measures a positional relationship between the main body and the object; and processing circuitry. The processing circuitry is configured to: calculate a self position that is a position of the main body on the travel map, based on the travel map generated by the travel map generation device and the positional relationship measured by the position sensor; generate a travel plan on the predetermined floor based on the travel map and the self position; and control the travel mechanism based on the travel plan.

Additionally, a travel control system for an autonomously traveling robot according to one aspect of the present disclosure is a travel control system for controlling travel of an autonomously traveling robot that travels autonomously over a predetermined floor. The travel control system includes: a sensor that detects an object in a vicinity of the sensor and obtains a positional relationship between the sensor and the object; and processing circuitry. The processing circuitry is configured to: calculate, based on the positional relationship, a first self position indicating a self position on a floor map representing the predetermined floor; obtain an image including reflected light produced by light emitted from a light emission device operated by a user; generate, based on the first self position and the image, information indicating an entry prohibited area into which the autonomously traveling robot is prohibited from entering, or a travel area for the autonomously traveling robot, in the floor map; generate a travel map for the autonomously traveling robot based on the information; calculate a second self position indicating a self position on the travel map; and generate a travel plan on the predetermined floor based on the travel map and the second self position.

Additionally, a travel control method for an autonomously traveling robot according to one aspect of the present disclosure is a travel control method for controlling travel of an autonomously traveling robot that travels autonomously over a predetermined floor. The travel control method includes: detecting an object in a vicinity of the autonomously traveling robot and obtaining a positional relationship between the autonomously traveling robot and the object; calculating a first self position indicating a self position on a floor map representing the predetermined floor; obtaining an image including reflected light produced by light emitted from a light emission device operated by a user; generating, based on the first self position calculated and the image obtained, information indicating an entry prohibited area into which the autonomously traveling robot is prohibited from entering, or a travel area for the autonomously traveling robot, in the floor map; generating, based on the information generated, a travel map for the autonomously traveling robot, the entry prohibited area being set in the travel map; calculating a second self position indicating a self position on the travel map generated; and generating a travel plan on the predetermined floor based on the travel map and the second self position.

Note that the present disclosure may be implemented as a program for causing a computer to implement the above-described travel control method. The present disclosure may also be implemented as a non-transitory recording medium, such as a CD-ROM, in which the above-described program is recorded, and which can be read by a computer. The present disclosure may also be implemented as information, data, or signals expressing that program. The programs, information, data, and signals may be distributed over a communication network such as the Internet.

### ADVANTAGEOUS EFFECTS

According to the travel map generation device of the present disclosure, an entry prohibited area, into which an autonomously traveling robot is prohibited from entering, can be easily set in a travel map for the autonomously traveling robot. In addition, according to the autonomously traveling robot of the present disclosure, the autonomously traveling robot can travel appropriately based on a travel map. In addition, according to the travel control system and the travel control method for an autonomously traveling robot of the present disclosure, the travel of the autonomously traveling robot can be controlled appropriately.

### BRIEF DESCRIPTION OF DRAWINGS

These and other advantages and features will become apparent from the following description thereof taken in conjunction with the accompanying Drawings, by way of non-limiting examples of

FIG. 1 is a diagram illustrating an overview of a travel control system of an autonomously traveling robot according to an embodiment.

FIG. 2 is a block diagram illustrating an example of the configuration of a travel control system for an autonomously traveling robot according to the embodiment.

FIG. 3 is a perspective view illustrating a travel map generation device according to the embodiment, viewed at an angle from above.

FIG. 4 is a front view illustrating the travel map generation device according to the embodiment, viewed from the front.

FIG. 5 is a perspective view illustrating the appearance of the autonomously traveling robot according to the embodiment, viewed from the side.

FIG. 6 is a perspective view illustrating the appearance of the autonomously traveling robot according to the embodiment, viewed from the front.

FIG. 7 is a bottom view illustrating the appearance of the autonomously traveling robot according to the embodiment, viewed from the rear.

FIG. 8 is a flowchart illustrating a first example of operations of the travel control system of the autonomously traveling robot according to the embodiment.

FIG. 9 is a flowchart illustrating the detailed flow of step S04 in the first example.

FIG. 10 is a diagram illustrating an example of an operation for generating entry prohibited information.

FIG. 11A is a diagram illustrating operations in light position determination made by an entry prohibited information generator.

FIG. 11B is a diagram illustrating an example of a determination method for determining a position of reflected light.

FIG. 12 is a flowchart illustrating a second example of operations of the travel control system of the autonomously traveling robot according to the embodiment.

FIG. 13 is a flowchart illustrating an example of operations performed by a terminal device in the second example.

FIG. 14 is a diagram illustrating an example of presentation information.

FIG. 15 is a diagram illustrating an example of a screen for accepting corrections to entry prohibited information.

FIG. 16 is a diagram illustrating an example of a screen for accepting the finalization of corrected entry prohibited information.

FIG. 17 is a flowchart illustrating a third example of operations of the travel control system of the autonomously traveling robot according to the embodiment.

### DESCRIPTION OF EMBODIMENTS

An exemplary embodiment of a travel map generation device and the like according to the present disclosure will be described in detail hereinafter with reference to the drawings. Note that the following embodiment describes a specific preferred example of the present disclosure. As such, the numerical values, shapes, materials, constituent elements, arrangements and connection states of constituent elements, steps, orders of steps, and the like in the following embodiment are merely examples, and are not intended to limit the present disclosure. Additionally, of the constituent elements in the following embodiment, constituent elements not denoted in the independent claims will be described as optional constituent elements.

Note that the accompanying drawings and the following descriptions are provided primarily so that those of ordinary skill in the art can sufficiently understand the present disclosure, and as such the content of the scope of claims is not intended to be limited by the drawings and descriptions in any way.

Additionally, the drawings are schematic diagrams, and are not necessarily exact illustrations. Configurations that are substantially the same are given the same reference signs in the drawings, and redundant descriptions may be omitted or simplified.

Additionally, expressions using terms such as “approximately”, such as “approximately triangular”, are used in the following embodiment. For example, “approximately triangular” means not only “perfectly triangular”, but also means “substantially triangular”, e.g., a triangle having rounded corners. The same applies to other uses of the term “approximately”.

Additionally, in the following embodiment, an autonomously traveling robot traveling on a floor surface of a predetermined floor being viewed vertically from above may be referred to as being in a “top view”, whereas being viewed vertically from below may be referred to as being in a “bottom view”.

### EMBODIMENT

### Autonomously Traveling Robot Travel Control System

### 1. Overview

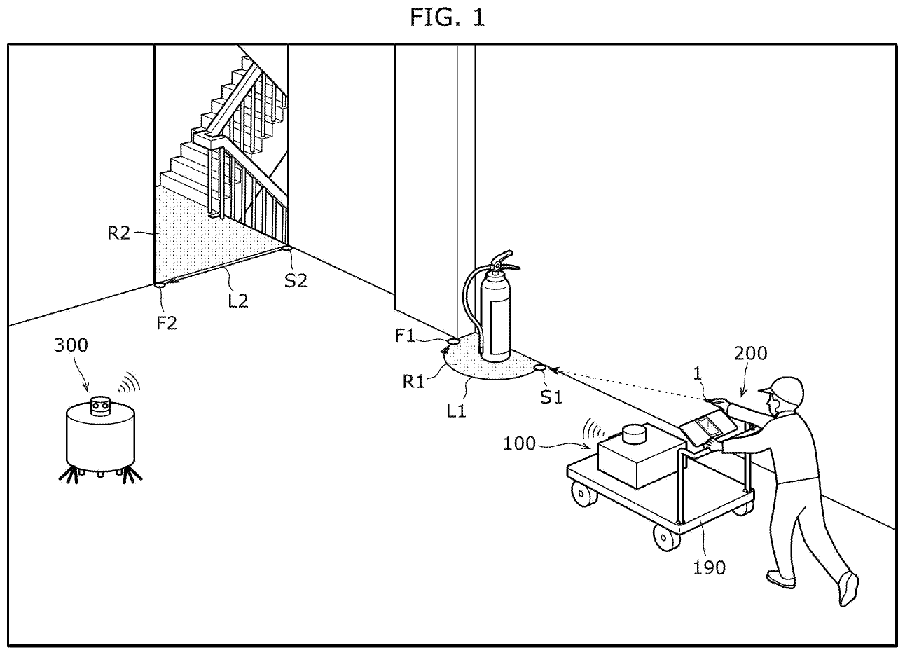

First, an overview of a travel control system for an autonomously traveling robot according to the embodiment will be described. FIG. 1 is a diagram illustrating an overview of the travel control system of the autonomously traveling robot according to the embodiment.

The travel control system for autonomously traveling robot 300 is a system for controlling the travel of an autonomously traveling robot that travels autonomously over a predetermined floor. The system is, for example, a system that sets an entry prohibited area on the predetermined floor into which autonomously traveling robot 300 is prohibited from entering, generates a travel map for autonomously traveling robot 300 that includes information (e.g., the position, shape, and size) on the set entry prohibited area, and generates a travel plan for autonomously traveling robot 300 based on the generated travel map. This makes it possible for autonomously traveling robot 300 to safely and appropriately travel autonomously over a predetermined floor.

The predetermined floor is, for example, a floor surrounded by walls and the like inside a building. The building may be, for example, a hotel, a commercial facility, an office building, a hospital, an assisted-living facility, an art museum, or a library, or may be a housing complex such as an apartment building.

As illustrated in FIG. 1, the travel control system of autonomously traveling robot 300 according to the embodiment includes, for example, travel map generation device 100, terminal device 200, and autonomously traveling robot 300.

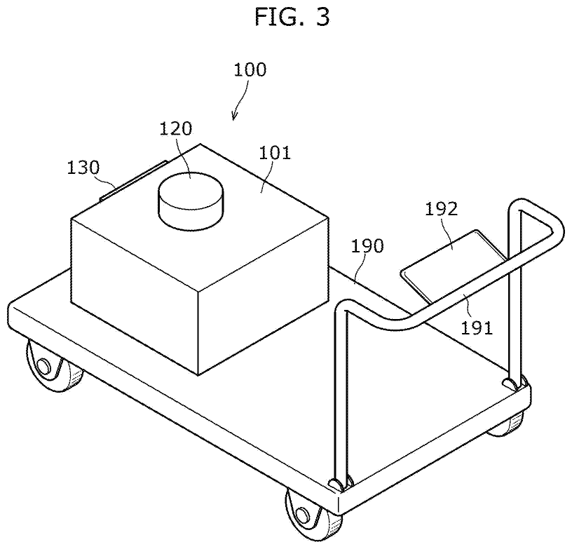

In the example illustrated in FIG. 1, travel map generation device 100 is mounted on dolly 190, and travels over the floor by a user pushing dolly 190, but is not limited thereto. For example, travel map generation device 100 may include a travel mechanism including wheels, a motor for rotating the wheels, and the like in main body 101 (see FIG. 3), and may travel over the floor by being operated using a remote controller or the like. Additionally, for example, travel map generation device 100 may further have a handle provided in main body 101, and in this case, travel map generation device 100 may be caused to travel by the user manipulating the handle.

Travel map generation device 100 is equipped with a position sensor using LiDAR (Light Detection and Ranging) or the like, for example, and obtains the positional relationships between the device itself and objects in the periphery while traveling over the floor. Travel map generation device 100 obtains a floor map representing the predetermined floor, and calculates a self position on the floor map based on the positional relationship between the device itself and the objects in the periphery. Travel map generation device 100 obtains an image including reflected light produced by light emitted from light emission device 1 (e.g., a laser pointer) operated by the user being reflected by the floor surface of the floor, and calculates coordinate information corresponding to the position of the reflected light in the floor map from the position of the reflected light in the obtained image based on the calculated self position.

For example, as illustrated in FIG. 1, the user may indicate a boundary between the entry prohibited area and a travel area (also called a “travelable area” hereinafter) by drawing line L1 on the floor surface with light emitted by light emission device 1. At this time, travel map generation device 100 may calculate a plurality of instances of coordinate information corresponding to each of a plurality of positions of light points of the reflected light in the floor map from the plurality of positions of light points of the reflected light included in line L1 from position S1 of the reflected light that is a drawing start position of line L1 in the image to position F1 of the reflected light that is a drawing end position, and determine the boundary based on the calculated plurality of instances of coordinate information.

Additionally, for example, travel map generation device 100 may set position S2 of reflected light produced by light emitted at a single color (e.g., red) by light emission device 1 as a starting position of the boundary, position F2 of reflected light produced by light emitted at another color (e.g., green) as an ending position of the boundary, and may set line segment L2 connecting those two positions as the boundary.

In this manner, based on coordinate information indicating a location on the floor map corresponding to the location of the reflected light in the image, travel map generation device 100 may determine a boundary between the entry prohibited area and the travelable area of autonomously traveling robot 300, and generate the entry prohibited information indicating the entry prohibited area of the predetermined floor. In this manner, travel map generation device 100 generates a travel map in which at least one entry prohibited area is set for the predetermined floor.

Terminal device 200, for example, presents presentation information generated by travel map generation device 100, accepts an instruction input by the user, and outputs the instruction to travel map generation device 100. The user may, for example, confirm the presentation information presented by terminal device 200 and input the instruction when the travel map is generated by travel map generation device 100. Additionally, the user may, for example, confirm the travel map after the travel map has been generated, confirm the presentation information associated with the travel map, and input the instruction. The presentation information will be described later. The user may confirm the presentation information presented (also called “displayed” hereinafter) by terminal device 200 and input an instruction to correct the position of the reflected light or the boundary in the floor map, an instruction to set a candidate for the entry prohibited area as the entry prohibited area, or the like, for example. Additionally, for example, the user may confirm the travel map displayed by terminal device 200 after the travel map is generated by travel map generation device 100, and input an instruction to correct the entry prohibited information or an instruction to delete the entry prohibited information to terminal device 200.

Autonomously traveling robot 300 generates a travel plan based on, for example, the travel map generated by travel map generation device 100, and autonomously travels over the predetermined floor according to the generated travel plan.

In this manner, in the travel control system for autonomously traveling robot 300, coordinates corresponding to the position of the reflected light in the floor map (also called “coordinate information”) can be calculated from an image including reflected light produced by the light emitted by the user onto the floor surface using light emission device 1, and the entry prohibited area can be set with ease based on those coordinates. Accordingly, the travel control system of autonomously traveling robot 300 can generate a travel plan for autonomously traveling robot 300 based on a travel map in which an entry prohibited area is set, which makes it possible to properly control the travel of autonomously traveling robot 300.

### 2. Configuration

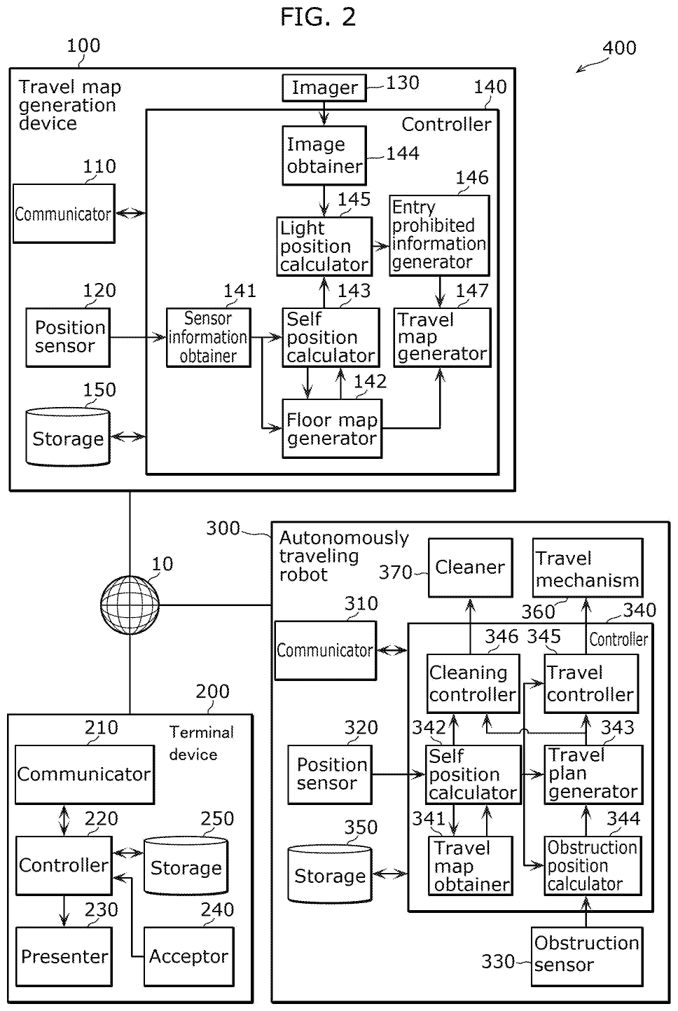

Next, the configuration of the travel control system for an autonomously traveling robot according to the embodiment will be described. FIG. 2 is a block diagram illustrating an example of the configuration of the travel control system for an autonomously traveling robot according to the embodiment.

Travel control system 400 according to the embodiment includes, for example, travel map generation device 100, terminal device 200, and autonomously traveling robot 300. Each constituent element will be described hereinafter.

### 2-1. Travel Map Generation Device

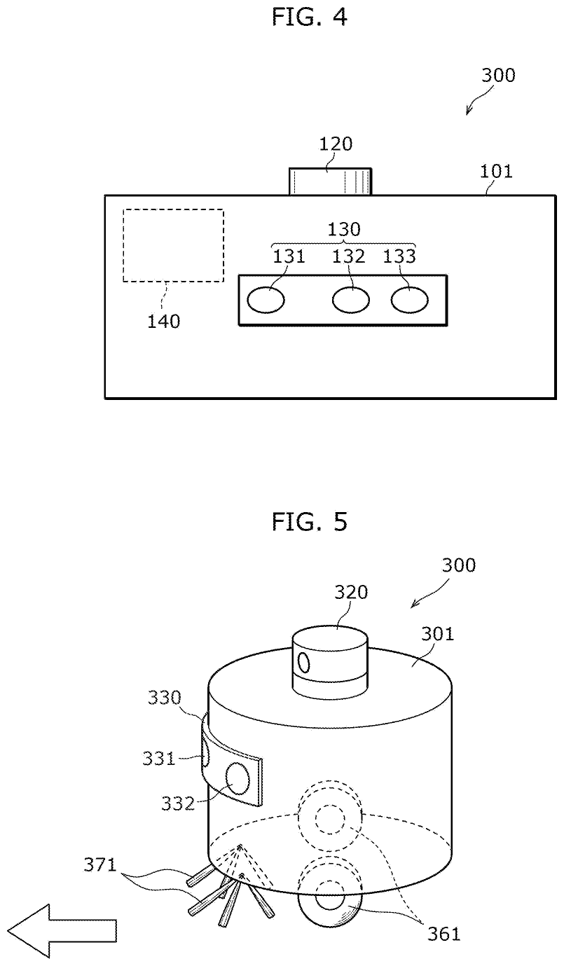

Travel map generation device 100 will be described first. FIG. 3 is a perspective view illustrating travel map generation device 100 according to the embodiment, viewed at an angle from above. FIG. 4 is a front view illustrating travel map generation device 100 according to the embodiment, viewed from the front.

Travel map generation device 100 is a device that generates a travel map for autonomously traveling robot 300 to travel autonomously over the predetermined floor. More specifically, while traveling on the predetermined floor by being operated by the user, travel map generation device 100 sets an entry prohibited area based on an image including reflected light produced by light emitted from light emission device 1 (see FIG. 1), and generates a travel map including the set entry prohibited area.

As illustrated in FIGS. 1 and 3, travel map generation device 100 is, for example, mounted on dolly 190, and travels over the predetermined floor by being operated by the user. Here, travel map generation device 100 is caused to travel by the user pushing dolly 190. Stand 192 on which terminal device 200 is mounted on handle 191 may be attached to dolly 190, for example, or a presenter (not shown) of travel map generation device 100 may be installed. The presenter may be what is known as a display panel.

Additionally, as illustrated in FIG. 2, travel map generation device 100 includes, for example, communicator 110, position sensor 120, imager 130, controller 140, and storage 150. Each constituent element will be described hereinafter.

### Communicator

Communicator 110 is a communication module (also called “communication circuitry”) for travel map generation device 100 to communicate with terminal device 200 and autonomously traveling robot 300 over wide-area communication network 10 such as the Internet. The communication performed by communicator 110 may be wireless communication or wired communication, for example. The communication standard used in the communication, too, is not particularly limited.

### Position Sensor

Position sensor 120 detects an object in the periphery of itself, and measures a positional relationship between the object and itself. For example, position sensor 120 is disposed in the center of the top surface of main body 101, and measures a positional relationship, including a distance and a direction, between travel map generation device 100 and an object, including a wall or the like, present in the periphery of travel map generation device 100. Position sensor 120 may be, for example, LIDAR or a lasing rangefinder that detects the positional relationship based on light emitted and then reflected back by an obstruction. Of these, position sensor 120 may be LIDAR. Position sensor 120 may perform two-dimensional measurement or three-dimensional measurement of a predetermined region in the periphery of travel map generation device 100 using one or two optical scanning axes.

Note that travel map generation device 100 may include other types of sensors in addition to position sensor 120. For example, travel map generation device 100 may further include a floor surface sensor, an encoder, an accelerometer, an angular velocity sensor, a contact sensor, an ultrasonic sensor, a range sensor, or the like.

### Imager

Imager 130 is an image capturing device that captures an image of the periphery of travel map generation device 100. For example, imager 130 captures an image including reflected light produced by the predetermined floor reflecting light emitted from light emission device 1 operated by the user. Imager 130 may be disposed on the front surface of main body 101, or may be disposed rotatably on the top surface. Additionally, imager 130 may be constituted by a plurality of cameras. Imager 130 may be, for example, a stereo camera or an RGB-D camera. An RGB-D camera obtains range image data (“depth”) in addition to color image data (“RGB”). For example, when imager 130 is an RGB-D camera, imager 130 may include RGB camera 131, infrared sensor 132, and projector 133.

### Controller

As illustrated in FIG. 2, controller 140 is processing circuitry that obtains sensor information, such as the positional relationship with an object in the periphery obtained by position sensor 120 sensing the surrounding environment of travel map generation device 100 and the image captured by imager 130, and performs various types of calculations. Specifically, controller 140 is implemented by a processor, a microcomputer, or dedicated circuitry. Additionally, controller 140 may be implemented by a combination of at least two of a processor, a microcomputer, or dedicated circuitry. For example, controller 140 includes sensor information obtainer 141, self position calculator 143, floor map generator 142, image obtainer 144, light position calculator 145, entry prohibited information generator 146, and travel map generator 147.

Sensor information obtainer 141 obtains the positional relationship with an object in the periphery, measured by position sensor 120. When travel map generation device 100 includes other types of sensors in addition to position sensor 120, sensor information obtainer 141 may further obtain sensor information obtained by the other types of sensors.

Floor map generator 142 generates a floor map representing the predetermined floor. Floor map generator 142 generates the floor map based on information obtained by position sensor 120 measuring the position and distance of the object (i.e., the positional relationship). Floor map generator 142 may generate the floor map with respect to the surrounding environment of travel map generation device 100 (objects such as walls, furniture, and the like) using Simultaneous Localization and Mapping (SLAM) technology, for example, based on the information obtained from position sensor 120. Note that in addition to the sensing information from position sensor 120 (e.g., LIDAR), floor map generator 142 may also use information from other sensors such as a wheel odometer, a gyrosensor, or the like, and furthermore, floor map generator 142 may obtain the floor map from terminal device 200 or a server (not shown), or may read out and obtain a floor map stored in storage 150.

Self position calculator 143 calculates a self position, which is the position of travel map generation device 100 in the floor map, using the relative positional relationship between position sensor 120 and the object obtained from position sensor 120, and the floor map. For example, self position calculator 143 calculates the self position using SLAM technology. In other words, when using SLAM technology, floor map generator 142 and self position calculator 143 generate the floor map while calculating the self position, and then sequentially update the self position and the floor map.

Image obtainer 144 obtains the image captured by imager 130. More specifically, image obtainer 144 obtains an image including reflected light produced by the predetermined floor reflecting light emitted from light emission device 1 operated by the user. The image may be a still image or a moving image. The image includes information such as an identification number (e.g., a pixel number) indicating the position of the reflected light in the image, and a distance for each pixel.

Light position calculator 145 calculates coordinate information corresponding to the position of the reflected light in the floor map from the position of the reflected light in the image obtained by image obtainer 144. For example, light position calculator 145 may obtain distance (i.e., relative distance) information for each pixel in the image obtained from imager 130 and calculate coordinate information corresponding to the position of the reflected light in the floor map from the position of the reflected light in the image, based on the relative positional relationship between position sensor 120 and the object obtained from position sensor 120, the floor map, and the distance information for each pixel in the image.

Additionally, for example, light position calculator 145 may determine the position of the reflected light in the image in accordance with the shape of the reflected light, and calculate the coordinate information corresponding to the position of the reflected light in the floor map from the determined position of the reflected light. The shape of light emitted differs depending on the type of light emission device 1. Accordingly, the reflected light produced by the light emitted from light emission device 1 may differ in shape depending on the type of light emission device 1. For example, when light emission device 1 is a laser pointer, when a single point is indicated by the laser pointer, the reflected light expresses a dot-like shape, and when a line is drawn on the floor surface using the laser pointer, the reflected light expresses a linear shape. Additionally, when light emission device 1 is, for example, a flashlight, the reflected light expresses a substantially circular or substantially elliptical shape. When light emission device 1 is, for example, a projector, the reflected light represents various shapes, such as an arrow, a star, a cross, a heart, a circle, a polygon, or the like. Accordingly, when the shape of the reflected light is a shape other than a linear shape, the coordinates indicating the light position of the reflected light may be coordinates indicating the center of the shape of the reflected light, and when the shape of the reflected light is a linear shape, the coordinates may be a plurality of coordinates indicating sequential points (i.e., a line) located at the center of the width direction of the line. Additionally, when the reflected light has an arrow shape, the coordinates indicating the light position of the reflected light may be coordinates indicating the tip of the arrow. These positions are not limited to the above examples, and may be determined as appropriate depending on the type of light emission device 1 used and the shape of the reflected light.

Additionally, light position calculator 145 may calculate a plurality of instances of coordinate information corresponding to each of a plurality of positions of the reflected light in the floor map from the plurality of positions of the reflected light in the image. For example, light position calculator 145 may calculate first coordinate information from a first position, which is a position in an image of reflected light produced by light emitted at a single color by light emission device 1, and second coordinate information from a second position, which is a position in an image of reflected light produced by light emitted at another color by light emission device 1. At this time, light position calculator 145 may identify the stated single color and other color from the RGB information for each pixel in the image, or may identify the single color and other color from luminance values.

Based on the coordinate information calculated by light position calculator 145, entry prohibited information generator 146 generates the entry prohibited information indicating the entry prohibited area. For example, entry prohibited information generator 146 determines whether the light position of the reflected light in the image is on the floor surface of the predetermined floor, and when the light position is determined to be on the floor surface, the entry prohibited information is generated using the light position. The stated determination may be made based on three-dimensional coordinate information in the image, or may be made by identifying the floor surface or the like using image recognition.

Additionally, based on the plurality of instances of coordinate information, entry prohibited information generator 146 may generate the entry prohibited information including boundary information indicating a boundary between the entry prohibited area and the travel area (travelable area) of the autonomously traveling robot. Note that entry prohibited information generator 146 may determine the boundary such that, for example, a region surrounded by a wall and a plurality of light positions is the entry prohibited area. See section 3, “Operations”, for the specific processing details.

Additionally, for example, based on the first coordinate information and the second coordinate information, entry prohibited information generator 146 may determine a line segment connecting the first position and the second position as the boundary. Note that when, for example, the first position and a wall are near each other, and the second position and the wall are near each other, entry prohibited information generator 146 may include a line segment connecting the first position and the wall, and a line segment connecting the second position and the wall, in the boundary.

Additionally, for example, entry prohibited information generator 146 may correct the entry prohibited information based on an instruction from the user. In this case, entry prohibited information generator 146 may generate presentation information to be presented to the user and present the information to the user. The presentation information is information for presenting to a user, and includes, for example, information such as the light position of the reflected light on the floor map, the boundary, the entry prohibited area or a candidate thereof, or the like. Specific examples of the presentation information will be described in a second example of operations.

Travel map generator 147 generates a travel map in which the entry prohibited area is set to prohibit autonomously traveling robot 300 from entering based on the entry prohibited information generated by entry prohibited information generator 146. Additionally, travel map generator 147 may correct the travel map based on the entry prohibited information corrected by entry prohibited information generator 146.

Travel map generator 147 outputs the generated travel map to terminal device 200 and autonomously traveling robot 300 through communicator 110.

### Storage

Storage 150 is a storage device that stores the floor map representing the predetermined floor, sensor information obtained by position sensor 120, image data captured by imager 130, and the like. Furthermore, storage 150 may store the floor map generated by floor map generator 142 and the travel map generated by travel map generator 147. Storage 150 also stores computer programs and the like executed by controller 140 for performing the aforementioned computation processing. Storage 150 is realized by a Hard Disk Drive (HDD), Flash memory, or the like, for example.

### 2-2. Terminal Device

Terminal device 200 will be described next. Terminal device 200 is, for example, a mobile information terminal such as a smartphone, a tablet terminal, or the like in the user's possession, but may be a stationary information terminal such as a personal computer or the like. Additionally, terminal device 200 may be a dedicated terminal of travel control system 400. Terminal device 200 includes communicator 210, controller 220, presenter 230, acceptor 240, and storage 250. Each constituent element will be described hereinafter.

### Communicator

Communicator 210 is communication circuitry for terminal device 200 to communicate with travel map generation device 100 and autonomously traveling robot 300 over wide-area communication network 10 such as the Internet. Communicator 210 is, for example, wireless communication circuitry that performs wireless communication. The communication standard of the communication by communicator 210 is not particularly limited.

### Controller

Controller 220 is processing circuitry that controls the display of images in acceptor 240, and performs identification processing and the like for instructions input by the user (for example, voice recognition processing, when voice is input). Controller 220 may be implemented by a microcomputer, for example, or may be implemented by a processor.

### Presenter

Presenter 230 presents the presentation information output by travel map generation device 100 and the travel map to the user. Presenter 230 may be implemented by a display panel, for example, or by a display panel and a speaker. The display panel is, for example, a liquid crystal panel, an organic EL panel, or the like. The speaker outputs sound or voice.

### Acceptor

Acceptor 240 accepts instructions from the user. More specifically, acceptor 240 accepts input operations for transmitting instructions from the user to travel map generation device 100. Acceptor 240 may be realized by, for example, a touch panel, a display panel, hardware buttons, a microphone, or the like. The touch panel may be, for example, a capacitive touch panel or a resistive touch panel. The display panel has a function for displaying images and a function for accepting manual inputs from the user, and accepts input operations to a numerical keypad image or the like displayed in the display panel, which is a liquid crystal panel or an organic electroluminescence (EL) panel. The microphone accepts voice input from the user.

Although an example in which acceptor 240 is a constituent element of terminal device 200 is described here, acceptor 240 may be integrated with at least one of the other constituent elements of travel control system 400. For example, acceptor 240 may be incorporated into travel map generation device 100, may be incorporated into a remote controller (not shown), or may be incorporated into autonomously traveling robot 300.

### Storage

Storage 250 is a storage device that stores a dedicated application program and the like for controller 220 to execute. Storage 250 is implemented by semiconductor memory or the like, for example.

### 2-3. Autonomously Traveling Robot

Autonomously traveling robot 300 will be described next. Autonomously traveling robot 300 is a robot that travels autonomously. For example, autonomously traveling robot 300 obtains the travel map generated by travel map generation device 100 and autonomously travels on the predetermined floor corresponding to the travel map. Autonomously traveling robot 300 is not particularly limited as long as it is a robot that travels autonomously, but may be, for example, a transport robot that transports items or a vacuum cleaner. The following will describe an example in which autonomously traveling robot 300 is a vacuum cleaner.

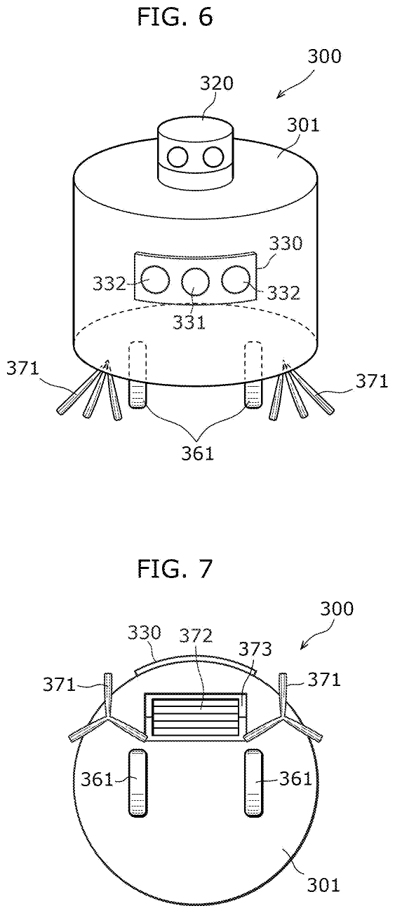

FIG. 5 is a perspective view illustrating the appearance of autonomously traveling robot 300 according to the embodiment, viewed from the side. FIG. 6 is a perspective view illustrating the appearance of autonomously traveling robot 300 according to the embodiment, viewed from the front. FIG. 7 is a bottom view illustrating the appearance of autonomously traveling robot 300 according to the embodiment, viewed from the rear.

As illustrated in FIGS. 5 to 7, autonomously traveling robot 300 includes, for example, main body 301, two side brushes 371, main brush 372, two wheels 361, and position sensor 320.

Main body 301 houses the various constituent elements included in autonomously traveling robot 300. In the present embodiment, main body 301 is substantially circular when seen in top view. Note that the shape of main body 301 in top view is not particularly limited. The top view shape of main body 301 may be, for example, an approximately rectangular shape, an approximately triangular shape, or an approximately polygonal shape. Main body 301 includes suction port 373 on a bottom surface thereof.

Side brushes 371 are brushes for cleaning the floor surface, and are provided on a bottom surface of main body 301. In the present embodiment, autonomously traveling robot 300 includes two side brushes 371. The number of side brushes 371 included in autonomously traveling robot 300 is not particularly limited, and may be one, or three or more.

Main brush 372 is a brush that is disposed within suction port 373, which is an opening provided in the bottom surface of main body 301, and that is for sweeping debris on the floor surface into suction port 373.

The two wheels 361 are wheels for enabling autonomously traveling robot 300 to travel.

As illustrated in FIGS. 2, 5, and 6, autonomously traveling robot 300 includes, for example, main body 301, position sensor 320, travel mechanism 360 which is disposed in main body 301 and which enables main body 301 to travel, and cleaner 370 that cleans the floor surface. Autonomously traveling robot 300 may further include obstruction sensor 330 in addition to position sensor 320. Travel mechanism 360 and cleaner 370 will be described in detail later.

### Position Sensor

Position sensor 320 is a sensor that detects an object in the periphery of main body 301 of autonomously traveling robot 300 and obtains a positional relationship of that object relative to main body 301. Position sensor 320 may be, for example, LIDAR or a lasing rangefinder that detects the positional relationship (e.g., the distance and direction from itself to the object) based on light emitted and then reflected back by an obstruction. Of these, position sensor 320 may be LIDAR.

### Obstruction Sensor

Obstruction sensor 330 is a sensor that detects surrounding walls present in front of main body 301 (specifically, in the direction of travel) and obstructions that will interfere with travel, such as furniture or the like. In the present embodiment, an ultrasonic sensor is used for obstruction sensor 330. Obstruction sensor 330 includes transmitter 331 disposed in the center of the front surface of main body 301 and receivers 332 disposed on both sides of transmitter 331, and by receiving ultrasonic waves transmitted from transmitter 331 and reflected back by an obstruction, receivers 332 can detect the distance, location, and so on of the obstruction.

Note that autonomously traveling robot 300 may include sensors other than the sensors described above. For example, floor surface sensors may be disposed in a plurality of locations on the bottom surface of main body 301, to detect whether a floor surface is present as the floor. Additionally, travel mechanism 360 may include an encoder that detects a rotation angle of each of the pair of wheels 361 rotated by a travel motor. Additionally, an accelerometer that detects acceleration when autonomously traveling robot 300 is traveling, and an angular velocity sensor that detects an angular velocity when autonomously traveling robot 300 is turning, may be provided. Additionally, a range sensor that detects a distance between autonomously traveling robot 300 and an obstruction present in the periphery of autonomously traveling robot 300 may be provided.

The functional configuration of autonomously traveling robot 300 will be described next with reference to FIG. 2.

Autonomously traveling robot 300 includes communicator 310, position sensor 320, obstruction sensor 330, controller 340, storage 350, travel mechanism 360, and cleaner 370. Position sensor 320 and obstruction sensor 330 have already been described above, and will therefore not be mentioned here.

### Communicator

Communicator 310 is communication circuitry for autonomously traveling robot 300 to communicate with travel map generation device 100 and terminal device 200 over wide-area communication network 10 such as the Internet. Communicator 310 is, for example, wireless communication circuitry that performs wireless communication. The communication standard of the communication by communicator 310 is not particularly limited.

### Controller

Controller 340 is processing circuitry that performs various types of calculations based on sensor information obtained by position sensor 320 and obstruction sensor 330 sensing the surrounding environment of autonomously traveling robot 300, as well as the travel map. Specifically, controller 340 is implemented by a processor, a microcomputer, or dedicated circuitry. Additionally, controller 340 may be implemented by a combination of at least two of a processor, a microcomputer, or dedicated circuitry. For example, controller 340 includes travel map obtainer 341, self position calculator 342, travel plan generator 343, obstruction position calculator 344, travel controller 345, and cleaning controller 346.

Travel map obtainer 341 obtains the travel map generated by travel map generation device 100. Travel map obtainer 341 may obtain the travel map by reading out a travel map stored in storage 350, or may obtain a travel map output by travel map generation device 100 through communication.

Self position calculator 342 calculates a self position, which is a position of main body 301 of autonomously traveling robot 300 on the travel map, based on, for example, the travel map obtained by travel map obtainer 341, and the positional relationship of objects in the periphery related to main body 301 of autonomously traveling robot 300 as obtained by position sensor 320.

Travel plan generator 343 generates a travel plan based on the travel map and the self position. For example, when autonomously traveling robot 300 is a vacuum cleaner as illustrated in FIGS. 2 and 5 to 7, travel plan generator 343 may further generate a cleaning plan. The cleaning plan includes, for example, a cleaning sequence for cleaning cleaning areas (e.g., rooms or sections) to be cleaned by autonomously traveling robot 300 when a plurality of such cleaning areas are present, a travel path and a cleaning mode in each area, and the like. The cleaning mode is, for example, a combination of a travel speed of autonomously traveling robot 300, a suction strength for suctioning debris on the floor surface, rotational speeds of the brushes, and the like.

Note that when autonomously traveling robot 300 is traveling in accordance with the travel plan, when obstruction sensor 330 detects an obstruction, travel plan generator 343 may change the travel plan based on the position of the obstruction calculated by obstruction position calculator 344. At this time, travel plan generator 343 may also change the cleaning plan.

Obstruction position calculator 344 obtains information pertaining to the obstruction detected by obstruction sensor 330 (e.g., the distance, position, and the like of the obstruction), and calculates the position of the obstruction in the floor map based on the obtained information and the self position calculated by self position calculator 342.

Travel controller 345 controls travel mechanism 360 such that autonomously traveling robot 300 travels in accordance with the travel plan. More specifically, based on the travel plan, travel controller 345 performs information processing for controlling the operation of travel mechanism 360. For example, based on information such as the travel map, the self position, and the like in addition to the travel plan, travel controller 345 derives control conditions for travel mechanism 360, and based on the control conditions, generates control signals for controlling the operation of travel mechanism 360. Travel controller 345 outputs the generated control signals to travel mechanism 360. Note that details such as the derivation of the control conditions for travel mechanism 360 are similar to those of conventional autonomously traveling robots, and will therefore not be described.

Cleaning controller 346 controls cleaner 370 such that autonomously traveling robot 300 cleans according to the cleaning plan. More specifically, based on the cleaning plan, cleaning controller 346 performs information processing for controlling the operation of cleaner 370. For example, based on information such as the travel map, the self position, and the like in addition to the cleaning plan, cleaning controller 346 derives control conditions for cleaner 370, and based on the control conditions, generates control signals for controlling the operation of cleaner 370. Cleaning controller 346 outputs the generated control signals to cleaner 370. Note that details such as the derivation of the control conditions for cleaner 370 are similar to those of conventional autonomously traveling vacuum cleaners, and will therefore not be described.

### Storage

Storage 350 is a storage device that stores the travel map, sensor information sensed by position sensor 320 and obstruction sensor 330, computer programs executed by controller 340, and the like. Storage 350 is implemented by semiconductor memory or the like, for example.

### Travel Mechanism

Travel mechanism 360 is disposed in main body 301 of autonomously traveling robot 300, and enables main body 301 to travel. Travel mechanism 360 includes, for example, a pair of travel units (not shown). The travel units are disposed on the left and right, respectively, relative to the center of autonomously traveling robot 300 in the width direction when viewed in plan view. Note that the number of travel units is not limited to two, and may be one, or may be three or more.

For example, the travel unit includes wheel 361 (see FIGS. 5 to 7) that travels on the floor surface, a travel motor (not shown) that applies torque to wheel 361, a housing (not shown) that houses the travel motor, and the like. Each wheel 361 of the pair of travel units is contained in a recess (not shown) formed in the bottom surface of main body 301, and is attached to main body 301 so as to be capable of rotating. Additionally, autonomously traveling robot 300 may be a differential two-wheeled type provided with a caster (not shown) as an auxiliary wheel. In this case, by independently controlling the rotation of wheels 361 of each of the pair of travel units, travel mechanism 360 can freely cause autonomously traveling robot 300 to travel forward, backward, rotate to the left, rotate to the right, and the like. When autonomously traveling robot 300 rotates to the left or right while moving forward or backward, autonomously traveling robot 300 turns to the left or right while moving forward or backward. On the other hand, when autonomously traveling robot 300 rotates left or right while not moving forward or backward, autonomously traveling robot 300 rotates while staying at its current position. In this manner, travel mechanism 360 causes main body 301 to move or rotate by independently controlling the operation of the pair of travel units. Travel mechanism 360 causes autonomously traveling robot 300 to travel by operating the travel motors and the like based on instructions from travel controller 345.

### Cleaner

Cleaner 370 is disposed in main body 301 of autonomously traveling robot 300, and performs at least one cleaning operation from among wiping, sweeping, and suctioning debris from the floor surface around main body 301. For example, cleaner 370 sucks debris such as dirt present on the floor surface from suction port 373 (see FIG. 7). Suction port 373 is provided at the bottom of main body 301 such that debris such as dirt present on the floor surface can be sucked into main body 301. Although not illustrated, cleaner 370 includes a brush travel motor that rotates side brushes 371 and main brush 372, a suction motor that suctions debris from suction port 373, a power transmitter that transmits power to the motors, and a debris receptacle that holds the suctioned debris. Cleaner 370 operates brush travel motor, suction motor, and the like based on control signals output from cleaning controller 346. Side brushes 371 sweep the debris on the floor surface around main body 301 and guide the debris to suction port 373 and main brush 372. As illustrated in FIGS. 5 to 7, autonomously traveling robot 300 includes two side brushes 371. Each side brush 371 is disposed on a side part of the front (i.e., the direction of forward travel) of main body 301, on the bottom surface thereof. The direction of rotation of each side brush 371 is a direction that enables debris to be collected from in front of main body 301 and brought toward suction port 373. Note that the number of side brushes 371 is not limited to two, and may be one, or may be three or more. The number of side brushes 371 may be selected as desired by the user. Additionally, each side brush 371 may be provided with a detachment structure.

### 3. Operations

Operations of travel control system 400 of autonomously traveling robot 300 according to the embodiment will be described next with reference to the drawings.

### First Example

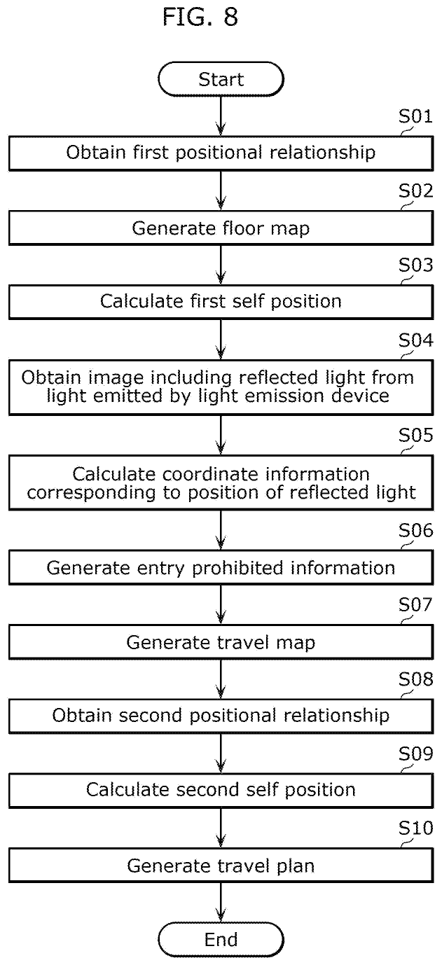

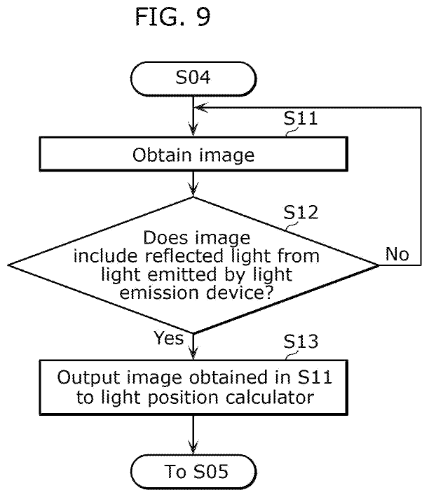

First, a first example of the operations of travel control system 400 of autonomously traveling robot 300 according to the embodiment will be described. The first example will describe an example in which travel control system 400 includes travel map generation device 100 and autonomously traveling robot 300. FIG. 8 is a flowchart illustrating the first example of operations of travel control system 400 of autonomously traveling robot 300 according to the embodiment. FIG. 9 is a flowchart illustrating the detailed flow of step S04 in the first example. The following descriptions will refer to FIGS. 2, 8, and 9.

Although not illustrated, travel map generation device 100 starts traveling in response to a user operation. Once travel starts, travel control system 400 performs the operations described hereinafter, for example. Note that travel map generation device 100 may travel by being operated by a user using a handle, or may travel by operating a joystick, a remote controller, or the like.

Sensor information obtainer 141 of travel map generation device 100 obtains a first positional relationship, which is a positional relationship of an object in the periphery relative to itself, measured by position sensor 120 (step S01). Position sensor 120 is LIDAR, for example. LIDAR measures the distance to an object such as a wall at predetermined angular intervals, and obtains data indicating the positions of measured measurement points.

Next, floor map generator 142 of travel map generation device 100 generates a floor map indicating a predetermined floor based on the first positional relationship obtained in step S01 (step S02). The predetermined floor is a region in which autonomously traveling robot 300 travels autonomously, and is, for example, a floor surrounded by walls or the like inside a building. For example, floor map generator 142 generates the floor map pertaining to the surrounding environment of travel map generation device 100 using SLAM technology, for example, based on the information obtained from position sensor 120 (i.e., the positional relationship).

Next, self position calculator 143 of travel map generation device 100 calculates a self position, which is the position of travel map generation device 100 on the floor map generated in step S02 (also called a “first self position” hereinafter) (step S03). For example, self position calculator 143 calculates the first self position, which is the position of travel map generation device 100 in the floor map, using the relative positional relationship between position sensor 120 and the object obtained from position sensor 120, and the floor map.

Note that travel map generation device 100 repeats steps S01 to S03 while traveling. In other words, floor map generator 142 and self position calculator 143 generate the floor map while calculating the first self position, and then sequentially update the first self position and the floor map, using SLAM technology. However, travel map generation device 100 may perform step S01 while traveling, and perform steps S02 and S03 after completing the travel over the predetermined floor.

Next, image obtainer 144 of travel map generation device 100 obtains an image including reflected light produced by the light emitted from light emission device 1 (step S04). More specifically, as illustrated in FIG. 9, in step S04, image obtainer 144 obtains an image of the periphery of travel map generation device 100, captured by imager 130 (step S11). Then, image obtainer 144 determines whether the obtained image includes reflected light produced by the light emitted from light emission device 1 (step S12). If image obtainer 144 determines that the obtained image does not include the reflected light (No in step S12), the sequence returns to step S11. On the other hand, if image obtainer 144 determines that the obtained image includes the reflected light, image obtainer 144 outputs the image obtained in step S11 (i.e., the image including the reflected light produced by the light emitted from light emission device 1) to light position calculator 145 (step S13).

Refer again to FIG. 8. Next, light position calculator 145 calculates coordinate information corresponding to the position of the reflected light in the floor map from the position of the reflected light in the image obtained in step S04 (step 505). In other words, based on the position of the reflected light in the image obtained in step S04, light position calculator 145 calculates coordinate information indicating a position in the floor map corresponding to the position of the reflected light. The image includes distance information (also called “depth information”) for each pixel. For example, light position calculator 145 obtains the distance information for each pixel in the image obtained in step S04, and based on the first positional relationship obtained in step S01, the floor map generated in step S02, and the distance information for each pixel in the image, calculates the coordinate information corresponding to the position of the reflected light in the floor map from the position of the reflected light in the image.

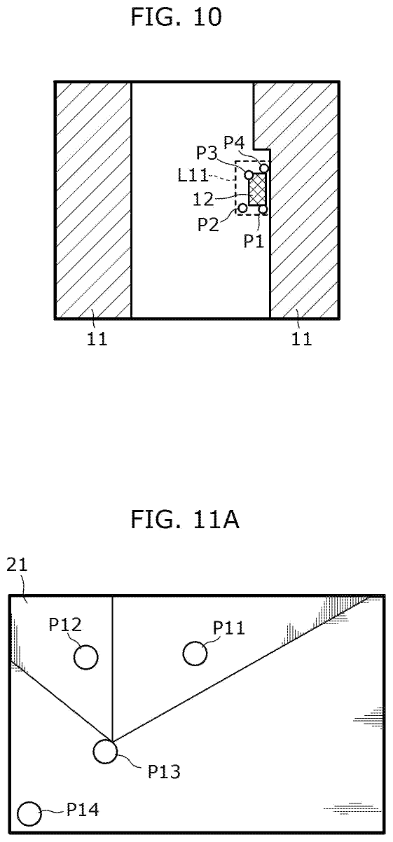

Next, based on the coordinate information calculated in step S05, entry prohibited information generator 146 generates entry prohibited information indicating an entry prohibited area in the predetermined floor into which the autonomously traveling robot is prohibited from entering (step S06). At this time, for example, entry prohibited information generator 146 may generate the entry prohibited information based on the coordinate information and the floor map, as illustrated in FIG. 10.

FIG. 10 is a diagram illustrating an example of an operation for generating the entry prohibited information. As illustrated in FIG. 10, when a plurality of positions P1, P2, P3, and P4 of reflected light are present in the periphery of obstruction 12 that is present next to wall 11, entry prohibited information generator 146 generates boundary information indicating boundary L11 between the entry prohibited area and the travelable area of autonomously traveling robot 300, based on the floor map and a plurality of instances of the coordinate information corresponding to respective ones of positions P1 to P4 of the reflected light in the floor map. At this time, entry prohibited information generator 146 may determine the boundary by deriving a line segment connecting the positions of the reflected light in the order in which the light is emitted from light emission device 1, and may determine the boundary so as to include the plurality of positions P1 to P4 of the reflected light and obstruction 12, for example, as illustrated in FIG. 10. At this time, entry prohibited information generator 146 may, for example, use a plurality of light positions of the reflected light produced by the light emitted within a set period of time (e.g., within one minute) to determine the boundary, and may determine whether the distance between the two closest light positions among the plurality of light positions is within a predetermined value and then use the light positions that are within the predetermined value to set the entry prohibited area.

In addition, in step S06, entry prohibited information generator 146 determines, for example, whether the position of the reflected light in the image obtained in step S04 is on the floor surface of the predetermined floor, and when that position is determined to be on the floor surface, the entry prohibited information is generated using that position.

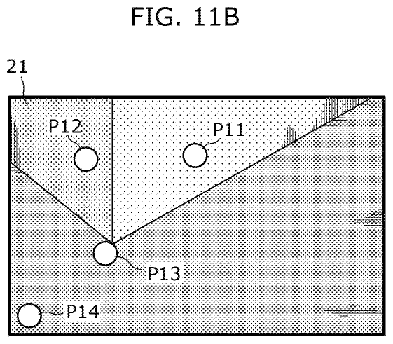

FIG. 11A is a diagram illustrating operations performed by entry prohibited information generator 146 in determining the light position (i.e., determining the position of the reflected light). As illustrated in FIG. 11A, the image obtained in step S04 includes positions P11 to P14 of the reflected light. Entry prohibited information generator 146 determines that positions P11 and P12 of the reflected light produced by the light emitted onto wall 21 are not on the floor surface in the obtained image, and does not use these positions to set the entry prohibited area (i.e., to generate the entry prohibited information). On the other hand, entry prohibited information generator 146 determines that positions P13 and P14 of the reflected light are on the floor surface, and uses these positions to set the entry prohibited area. The determination as to whether the position of the reflected light is on the floor surface may be made based on three-dimensional coordinate information in the image, or may be made by identifying the wall, the floor surface, and the like using image recognition.

A method for determining whether the position of the reflected light is on the floor surface will be described here in detail. FIG. 11B is a diagram illustrating an example of a determination method for determining the position of the reflected light. For example, as indicated in FIG. 11B, entry prohibited information generator 146 may use the semantic segmentation method on each pixel of the image obtained in step S04 to identify the type of an object constituted by the pixels. Additionally, for example, entry prohibited information generator 146 may use the instance segmentation method on the image obtained in step S04 to assign an individual ID to each of individual objects when individual objects of the same type are different and identify those individual objects as being of different types. Specifically, when two objects identified as “walls” are present in the image, entry prohibited information generator 146 may handle one “wall” and the other “wall” as different objects.

In this manner, entry prohibited information generator 146 may determine whether the position of the reflected light is on the floor surface by using an image recognition method such as segmentation.

Additionally, for example, a three-dimensional position (i.e., three-dimensional coordinates) corresponding to a pixel position of the reflected light in an RGB image may be calculated using a three-dimensional Time of Flight (ToF) camera and an RGB camera, or an RGB-D camera, and the position of the reflected light may be determined to be on the floor surface when the calculated coordinates are located at the height of the floor surface in the height direction. Note that the RGB camera is not limited to a single-lens camera, and may be a stereo camera or an omnidirectional camera.

Refer again to FIG. 8. Next, travel map generator 147 of travel map generation device 100 generates the travel map in which the entry prohibited area is set based on the entry prohibited information generated in step S06 (step S07). For example, travel map generator 147 may associate the floor map generated in step S02 with boundary information (i.e., coordinate information indicating the boundary), the position and range of the entry prohibited area, information pertaining to obstructions present in the entry prohibited area, and the like.

Note that travel map generation device 100 may perform steps S01 and S04 while traveling, and after finishing traveling over the predetermined floor, may generate the travel map by performing the steps other than steps S01 and S04.

Next, travel map obtainer 341 of autonomously traveling robot 300 obtains the travel map generated in step S07 (not shown).

Next, sensor information obtainer 141 of autonomously traveling robot 300 obtains a second positional relationship, which is a positional relationship of an object relative to itself, measured by position sensor 320 (step S08).

Next, based on the second positional relationship obtained in step S08, self position calculator 342 of autonomously traveling robot 300 calculates a self position (also called a “second self position” hereinafter), which is the position of autonomously traveling robot 300 on the travel map (step S09).

Next, travel plan generator 343 of autonomously traveling robot 300 generates a travel plan based on the travel map and the second self position (step S10).

Next, travel controller 345 of autonomously traveling robot 300 controls travel mechanism 360, which is disposed in main body 301 and enables main body 301 to travel, based on the travel plan generated in step S10 (not shown).

As described above, travel control system 400 generates a travel map in which an entry prohibited area is set and generates a travel plan based on the generated travel map, and can therefore appropriately control travel of autonomously traveling robot 300.

Although the first example describes an example in which travel control system 400 includes travel map generation device 100 and autonomously traveling robot 300 as separate entities, the configuration is not limited thereto. For example, travel control system 400 may include autonomously traveling robot 300 that includes the functions of travel map generation device 100 (called an “integrated robot”). Such an integrated robot may travel in response to operations by a user when generating a travel map, and may travel autonomously according to a travel plan when traveling based on the travel map, for example.

Additionally, for example, when travel control system 400 is an integrated robot as described above, the stated first self position and second self position are the self position of the integrated robot, and a first self position calculator and a second self position calculator are realized by a single self position calculator.

Additionally, for example, the integrated robot may include a notifier (not shown) that provides a notification to the periphery that operations for setting an entry prohibited area are underway. The notifier may, for example, make the notification using sound or voice, by emitting light, or by a combination of these.

Providing a notification to the periphery that operations for setting an entry prohibited area are underway makes it easier for travel control system 400 to smoothly perform the operations for setting the entry prohibited area.

### Second Example

Next, a second example of the operations of travel control system 400 of autonomously traveling robot 300 according to the embodiment will be described. Although the first example described generating the entry prohibited information indicating an entry prohibited area including a boundary drawn by light emitted from light emission device 1 by the user, the second example will describe an example of operations performed when an instruction to correct the entry prohibited information is accepted from the user. Note that the second example will focus on points that are different from the first example, and descriptions of the common processes will be omitted or simplified.

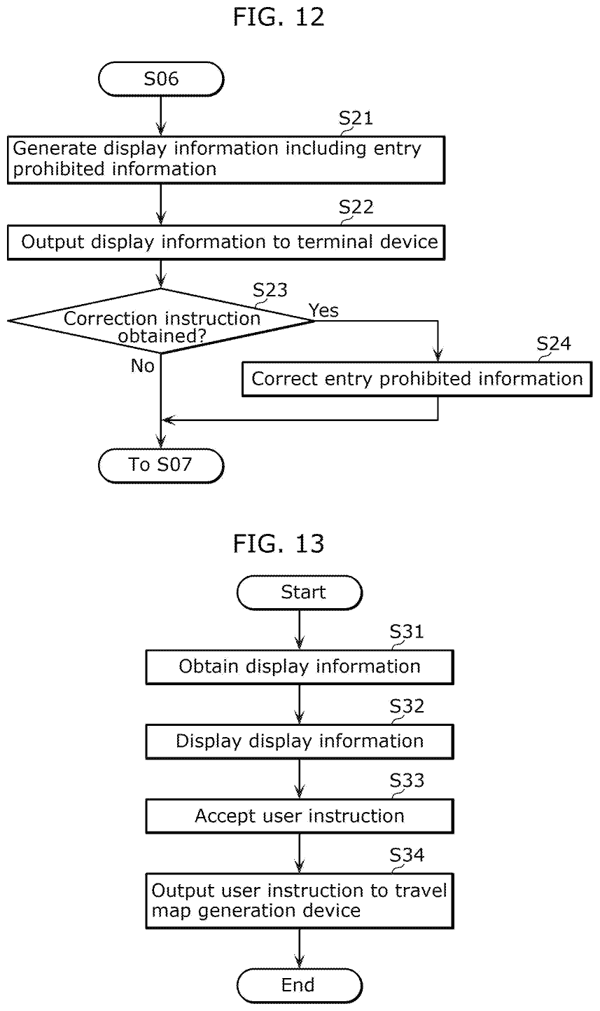

FIG. 12 is a flowchart illustrating the second example of operations of travel control system 400 of autonomously traveling robot 300 according to the embodiment. FIG. 12 illustrates only processes that are different from the first example illustrated in FIG. 8. Additionally, FIG. 13 is a flowchart illustrating an example of operations performed by a terminal device in the second example.

Continuing from step S06 of FIG. 8, entry prohibited information generator 146 generates presentation information, which is information to be presented to the user and which includes the entry prohibited information generated in step S06 (step S21).

Next, entry prohibited information generator 146 outputs the presentation information generated in step S21 to terminal device 200 used by the user (step S22).

Next, as illustrated in FIG. 13, terminal device 200 obtains the presentation information output in step S22 (step S31) and causes presenter 230 to present the obtained presentation information (step S32). Upon accepting an instruction from the user (step S33), acceptor 240 of terminal device 200 outputs the user's instruction to travel map generation device 100 (step S34).

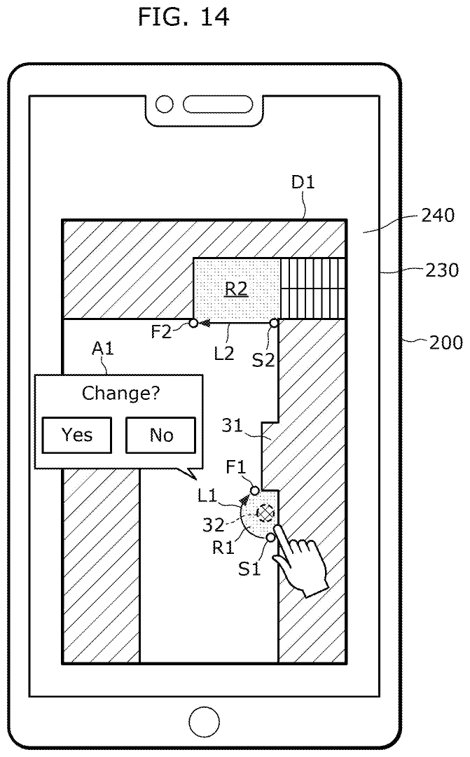

Note that presenter 230 may be a display (e.g., a display panel) that displays an image, or may include a display an audio outputter (e.g., a speaker). An example in which the presentation information is an image and presenter 230 is a display will be described here. FIG. 14 is a diagram illustrating an example of the presentation information. Details described with reference to FIG. 1 will be omitted from the descriptions of FIG. 14.

In the example illustrated in FIG. 14, presenter 230 of terminal device 200 presents presentation information D1. Presentation information D1 illustrates positional relationships among wall 31, obstruction 32, light positions S1, F1, S2, and F2 of reflected light produced by light emitted from light emission device 1, lines L1 and L2 indicating boundaries, and entry prohibited areas R1 and R2.

The user may confirm presentation information D1 presented by presenter 230 and input an instruction to correct the entry prohibited information, such as an instruction to correct a position, including shifting at least one light position among the plurality of light positions, an instruction to delete an unnecessary light position, and the like. For example, when the user touches a part of entry prohibited area R1 displayed in presenter 230 with their finger, acceptor 240 displays object A1 for accepting an instruction to correct the entry prohibited information. When the user touches “yes” in object A1, acceptor 240 switches to a screen for accepting a correction to the entry prohibited information by the user.

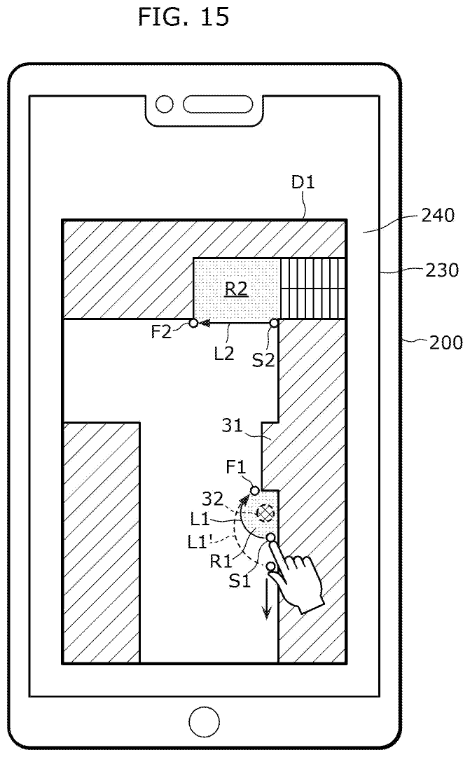

FIG. 15 is a diagram illustrating an example of a screen for accepting corrections to the entry prohibited information. As illustrated in FIG. 15, the user may correct the position of light position S1 by touching light position S1 in presentation information D1 displayed in presenter 230 with their finger and dragging in a desired direction (here, the downward direction of the screen). By accepting the input operation described above, acceptor 240 outputs, to travel map generation device 100, an instruction to correct light position S1 to S1′, correct line L1 indicating the boundary to line L1′, and correct entry prohibited area R1 to R1′.

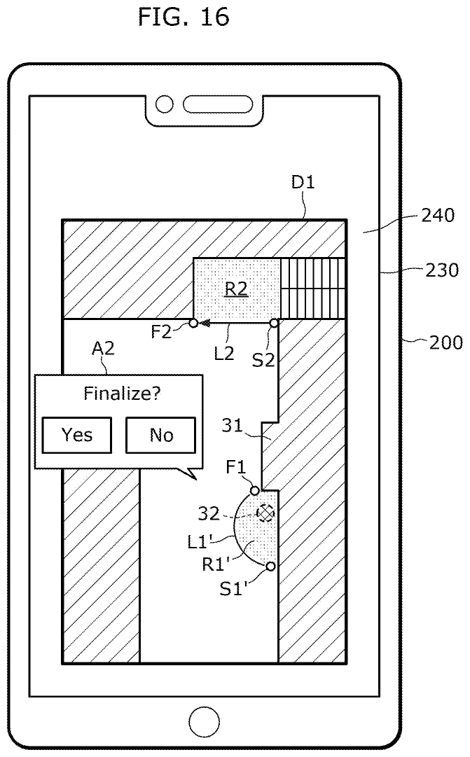

Note that acceptor 240 may further accept an instruction to finalize the corrected entry prohibited information and output the finalized correction instruction to travel map generation device 100 as an instruction from the user. FIG. 16 is a diagram illustrating an example of a screen for accepting the finalization of the corrected entry prohibited information. For example, as illustrated in FIG. 16, acceptor 240 may display object A2 for accepting an input pertaining to the finalization of the entry prohibited area. By finalizing the correction instruction in this manner, the instruction from the user can be accurately accepted and output to travel map generation device 100.

Refer again to FIG. 12. When travel map generation device 100 obtains the user instruction output in step S34 of FIG. 13 (here, the correction instruction) (Yes in step S23), entry prohibited information generator 146 corrects the entry prohibited information based on the obtained correction instruction (step S24). On the other hand, if travel map generation device 100 does not obtain a correction instruction (No in step S23), i.e., if a correction instruction is not made by the user, travel map generator 147 of travel map generation device 100 performs the processing of step S07 in FIG. 8.

As described above, travel control system 400 can accept a user instruction and correct the entry prohibited information, which makes it possible to appropriately set the entry prohibited area. Accordingly, travel control system 400 generates a travel plan based on a travel map in which an entry prohibited area is set appropriately, which makes it possible to more appropriately control the travel of autonomously traveling robot 300.

In the second example, when a travel map is being generated, a user instruction is accepted and the entry prohibited information is corrected, but the user instruction may be accepted and the entry prohibited information may be changed after the travel map has been generated.

### Third Example

Next, a third example of the operations of travel control system 400 of autonomously traveling robot 300 according to the embodiment will be described. The third example will describe an example of operations performed when an obstruction is detected in the travel path while autonomously traveling robot 300 travels in accordance with a travel plan generated based on the travel map.

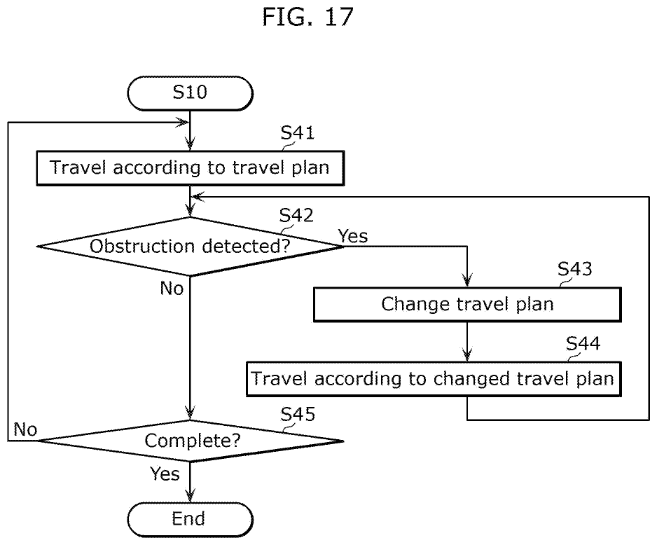

FIG. 17 is a flowchart illustrating the third example of operations of travel control system 400 of autonomously traveling robot 300 according to the embodiment. FIG. 17 illustrates processing which follows step S10 in FIG. 8.

Continuing from step S10 in FIG. 8, travel controller 345 of autonomously traveling robot 300 controls the operation of travel mechanism 360 based on the travel plan. Through this, autonomously traveling robot 300 travels in accordance with the travel plan (step S41).

When an obstruction is detected in front of autonomously traveling robot 300 (i.e., in the direction of travel) by obstruction sensor 330 of autonomously traveling robot 300 (Yes in step S42), obstruction position calculator 344 changes the travel plan to avoid the obstruction based on information such as the position and distance of the obstruction obtained from obstruction sensor 330 (step S43). Travel controller 345 then controls the operations of travel mechanism 360 based on the changed travel plan. As a result, autonomously traveling robot 300 travels so as to avoid the obstruction in accordance with the changed travel plan (step S44).

On the other hand, if no obstruction has been detected by obstruction sensor 330 (No in step S42), and if autonomously traveling robot 300 has not completed the execution of the travel plan (No in step S45), autonomously traveling robot 300 returns to step S41. On the other hand, if the execution of the travel plan has been completed (Yes in step S45), autonomously traveling robot 300 returns to a charging spot, for example, whereupon the operations end.

As described above, when an obstruction is detected in the travel path while autonomously traveling robot 300 is traveling based on a travel plan, travel control system 400 can change the travel plan to avoid the obstruction, and can therefore appropriately control the travel of autonomously traveling robot 300.

### 4. Effects, etc.

Travel map generation device 100 is a travel map generation device that generates a travel map for autonomously traveling robot 300 that travels autonomously over a predetermined floor, and includes: sensor information obtainer 141 that obtains a positional relationship from position sensor 120 that detects an object in a vicinity of travel map generation device 100 and measures a positional relationship between travel map generation device 100 and the object; floor map generator 142 that generates a floor map representing a predetermined floor based on the positional relationship obtained by sensor information obtainer 141; self position calculator 143 that calculates a self position on the floor map generated by floor map generator 142; image obtainer 144 that obtains an image including reflected light produced by the predetermined floor reflecting light emitted from light emission device 1 operated by the user; light position calculator 145 that calculates coordinate information corresponding to the position of the reflected light in the floor map from the position of the reflected light in the image obtained by image obtainer 144, based on the self position calculated by self position calculator 143; entry prohibited information generator 146 that generates entry prohibited information indicating an entry prohibited area in the floor map into which autonomously traveling robot 300 is prohibited from entering, based on the coordinate information calculated by light position calculator 145; and travel map generator 147 that generates a travel map in which the entry prohibited area is set, based on the entry prohibited information generated by entry prohibited information generator 146.

Through this, travel map generation device 100 can easily set an entry prohibited area in the travel map.

For example, in travel map generation device 100, entry prohibited information generator 146 may determine whether a position of the reflected light in the image is on a floor surface of the predetermined floor, and generate the entry prohibited information using the position when the position is determined to be on the floor surface.

Through this, travel map generation device 100 can generate the entry prohibited information using two-dimensional coordinate information, which makes it easy to set the entry prohibited area in the travel map.

For example, in travel map generation device 100, light position calculator 145 may determine a position of the reflected light in the image according to a shape of the reflected light, and calculate the coordinate information corresponding to the position of the reflected light in the floor map based on the position of the reflected light determined.

Through this, travel map generation device 100 can calculate coordinate information corresponding to the position of the reflected light determined in accordance with the shape of the reflected light, and can therefore calculate coordinate information indicating the light position of the reflected light according to the type of light emission device 1, e.g., a laser pointer, a flashlight, a projector, or the like.

For example, in travel map generation device 100, light position calculator 145 may calculate a plurality of pieces of coordinate information corresponding to each of a plurality of positions of the reflected light in the floor map from the plurality of positions of the reflected light in the image, and based on the plurality of pieces of coordinate information, entry prohibited information generator 146 may generate the entry prohibited information including boundary information indicating a boundary between the entry prohibited area and the travel area of autonomously traveling robot 300.

Through this, travel map generation device 100 can appropriately determine a boundary of the entry prohibited area based on the object information and the plurality of instances of coordinate information in the floor map.

For example, in travel map generation device 100, light position calculator 145 may calculate first coordinate information from a first position that is a position, in the image, of reflected light produced by light of one color emitted from light emission device 1, and calculate second coordinate information from a second position that is a position, in the image, of reflected light produced by light of another color emitted from light emission device 1; and entry prohibited information generator 146 may determine a line segment connecting the first position and the second position as the boundary, based on the first coordinate information and the second coordinate information.

Through this, travel map generation device 100 can, for example, determine the boundary using the positions of two colors of reflected light as a starting point and an ending point of the boundary, which makes it easy to set the entry prohibited area in the travel map.

For example, in travel map generation device 100, entry prohibited information generator 146 may correct the entry prohibited information based on an instruction from the user, and travel map generator 147 may correct the travel map based on the entry prohibited information corrected by entry prohibited information generator 146.

Through this, travel map generation device 100 can appropriately set an entry prohibited area desired by the user.

Additionally, autonomously traveling robot 300 is an autonomously traveling robot that travels autonomously over a predetermined floor, and includes: main body 301; travel mechanism 360 that is disposed in main body 301 and that enables main body 301 to travel; travel map obtainer 341 that obtains a travel map generated by travel map generation device 100; position sensor 320 that detects a position of an object in a vicinity of main body 301 and measures a positional relationship between main body 301 and the object; self position calculator 342 that calculates a self position that is a position of main body 301 on the travel map, based on the travel map and the positional relationship; travel plan generator 343 that generates a travel plan on the predetermined floor based on the travel map and the self position; and travel controller 345 that controls travel mechanism 360 based on the travel plan.

Through this, autonomously traveling robot 300 can generate a travel plan based on the travel map in which the entry prohibited area is set, and can therefore travel safely and appropriately.

For example, autonomously traveling robot 300 may further include: cleaner 370 that cleans a floor surface by executing at least one of wiping, sweeping, or suctioning debris; and cleaning controller 346 that controls cleaner 370. Travel plan generator 343 may further generate a cleaning plan, and cleaning controller 346 may control cleaner 370 based on the cleaning plan.

Through this, autonomously traveling robot 300 can clean safely and appropriately.

Travel control system 400 is a travel control system for controlling travel of autonomously traveling robot 300 that travels autonomously over a predetermined floor, and includes: sensor information obtainer 141 that obtains a positional relationship from position sensor 120 that detects an object in a vicinity of travel map generation device 100 and measures a positional relationship between travel map generation device 100 and the object; floor map generator 142 that generates a floor map representing a predetermined floor based on the positional relationship obtained by sensor information obtainer 141; first self position calculator (e.g., self position calculator 143) that calculates a first self position indicating a self position on the floor map generated by floor map generator 142; image obtainer 144 that obtains an image including reflected light produced by the predetermined floor reflecting light emitted from light emission device 1 operated by the user; light position calculator 145 that calculates coordinate information corresponding to the position of the reflected light in the floor map from the position of the reflected light in the image obtained by image obtainer 144, based on the first self position calculated by first self position calculator 143; entry prohibited information generator 146 that generates entry prohibited information indicating an entry prohibited area in the floor map into which autonomously traveling robot 300 is prohibited from entering, based on the coordinate information calculated by light position calculator 145; travel map generator 147 that generates a travel map for autonomously traveling robot 300 in which the entry prohibited area is set, based on the entry prohibited information generated by entry prohibited information generator 146; second self position calculator (e.g., self position calculator 342) that calculates a second self position indicating a self position on the travel map generated by travel map generator 147; and travel plan generator 343 that generates a travel plan on the predetermined floor based on the travel map and the second self position.

Through this, travel control system 400 of autonomously traveling robot 300 can generate a travel plan using a travel map in which an entry prohibited area is set, which makes it possible for autonomously traveling robot 300 to travel safely and appropriately.

For example, travel control system 400 may further include acceptor 240 that accepts an instruction from the user. Entry prohibited information generator 146 may correct the entry prohibited information based on the instruction accepted by acceptor 240, and travel map generator 147 may correct the travel map based on the entry prohibited information corrected by entry prohibited information generator 146.

Through this, travel control system 400 of autonomously traveling robot 300 can correct the entry prohibited information based on an instruction from the user, which makes it possible to generate a travel plan using a travel map in which the entry prohibited area has been more appropriately set. Accordingly, travel control system 400 can cause autonomously traveling robot 300 to travel safely and appropriately.

Additionally, a travel control method for autonomously traveling robot 300 is a travel control method for controlling travel of autonomously traveling robot 300 that travels autonomously over a predetermined floor. The travel control method includes: obtaining a positional relationship from position sensor 120 that detects an object in a vicinity of autonomously traveling robot 300 and measures a positional relationship between autonomously traveling robot 300 and the object; generating a floor map indicating a predetermined floor based on the positional relationship obtained; calculating a first self position indicating a self position on the floor map generated; obtaining an image including reflected light produced by the predetermined floor reflecting light emitted from light emission device 1 operated by a user; calculating, based on the first self position calculated, coordinate information corresponding to a position of the reflected light in the floor map from the position of the reflected light in the image obtained; generating entry prohibited information indicating an entry prohibited area in the floor map into which autonomously traveling robot 300 is prohibited from entering, based on the coordinate information calculated; generating, based on the entry prohibited information generated, a travel map for autonomously traveling robot 300 in which the entry prohibited area is set; and calculating a second self position indicating a self position on the travel map generated; and generating a travel plan on the predetermined floor based on the travel map and the second self position.

Through this, the travel control method for autonomously traveling robot 300 can generate a travel plan using a travel map in which an entry prohibited area is set, which makes it possible for autonomously traveling robot 300 to travel safely and appropriately.

For example, the travel control method may further include: accepting an instruction from a user; correcting the entry prohibited information based on the instruction accepted; and correcting the travel map based on the entry prohibited information corrected.

Through this, the travel control method of autonomously traveling robot 300 can correct the entry prohibited information based on an instruction from the user, which makes it possible to generate a travel plan using a travel map in which the entry prohibited area has been more appropriately set. Accordingly, the travel control method can cause autonomously traveling robot 300 to travel safely and appropriately.

### OTHER EMBODIMENTS

Although an embodiment has been described thus far, the present disclosure is not limited to the foregoing embodiment.

For example, in the embodiment, travel map generation device 100 includes position sensor 120 and imager 130, but position sensor 120 and imager 130 need not be provided. For example, travel map generation device 100 may be an information processing device that includes the constituent elements other than position sensor 120 and imager 130. In this case, sensors including position sensor 120 and imager 130 may be mounted on dolly 190, and data obtained by the sensors while moving over the predetermined floor may be output to the information processing device.

Although implemented by a plurality of devices in the embodiment, for example, travel control system 400 may instead be implemented as a single device. Additionally, if the system is implemented by a plurality of devices, the constituent elements provided in travel control system 400 may be distributed among the plurality of devices in any manner. Additionally, for example, a server device capable of communicating with travel control system 400 may include a plurality of constituent elements included in controllers 140 and 340.

For example, the method through which the devices communicate with each other in the foregoing embodiment is not particularly limited. Additionally, a relay device (not shown) may relay the communication among the devices.

Additionally, processing executed by a specific processing unit in the foregoing embodiment may be executed by a different processing unit. Additionally, the order of multiple processes may be changed, and multiple processes may be executed in parallel.

Additionally, in the foregoing embodiments, the constituent elements may be implemented by executing software programs corresponding to those constituent elements. Each constituent element may be realized by a program executing unit such as a CPU or a processor reading out and executing a software program recorded into a recording medium such as a hard disk or semiconductor memory.

Each constituent element may be implemented by hardware. For example, each constituent element may be circuitry (or integrated circuitry). This circuitry may constitute a single overall circuit, or may be separate circuits. The circuitry may be generic circuitry, or may be dedicated circuitry.

The general or specific aspects of the present disclosure may be implemented by a system, a device, a method, an integrated circuit, a computer program, or a computer-readable recording medium such as a CD-ROM. These forms may also be implemented by any desired combination of systems, devices, methods, integrated circuits, computer programs, and recording media.

For example, the present disclosure may be implemented as a travel control method executed by a computer such as travel control system 400, or as a program for causing a computer to execute such a travel control method. The present disclosure may also be realized as a program for causing a general-purpose computer to operate as terminal device 200 according to the foregoing embodiment. The present disclosure may be implemented as a non-transitory computer-readable recording medium in which the program is recorded.

Additionally, embodiments achieved by one skilled in the art making various conceivable variations on the embodiments, embodiments achieved by combining constituent elements and functions from the embodiments as desired within a scope which does not depart from the spirit of the present disclosure, and the like are also included in the present disclosure.

### INDUSTRIAL APPLICABILITY

The present disclosure can be widely used in robots that travel autonomously.

1. A travel map generation device that generates a travel map for an autonomously traveling robot that travels autonomously over a predetermined floor, the travel map generation device comprising:
a sensor that detects an object in a vicinity of the travel map generation device and obtains a positional relationship between the travel map generation device and the object; and
processing circuitry,
wherein the processing circuitry is configured to:
calculate, based on the positional relationship, a self position on a floor map representing the predetermined floor;
obtain an image including reflected light produced by light emitted from a light emission device operated by a user; and
generate, based on the self position and the image, information indicating an entry prohibited area into which the autonomously traveling robot is prohibited from entering, or a travel area for the autonomously traveling robot, in the floor map.

2. The travel map generation device according to claim 1,
wherein the processing circuitry is further configured to:
generate the floor map representing the predetermined floor based on the positional relationship obtained by the sensor; and
generate the travel map, in which the entry prohibited area is set, based on the floor map and the information.

3. The travel map generation device according to claim 1,
wherein the processing circuitry is further configured to:
determine whether a position of the reflected light in the image is on a floor surface of the predetermined floor; and
generate the information using the position when the position is determined to be on the floor surface.

4. The travel map generation device according to claim 1,
wherein the processing circuitry is further configured to:
calculate, based on the self position, coordinate information corresponding to a position of the reflected light in the floor map from a position of the reflected light in the image; and
generate the information based on the coordinate information calculated.

5. The travel map generation device according to claim 4,
wherein the processing circuitry is further configured to:
determine the position of the reflected light in the image according to a shape of the reflected light; and
calculate the coordinate information corresponding to the position of the reflected light in the floor map based on the position determined.

6. The travel map generation device according to claim 4,
wherein the processing circuitry is further configured to:
calculate a plurality of instances of the coordinate information, each corresponding to a respective one of a plurality of positions of the reflected light in the floor map, from corresponding ones of a plurality of positions of the reflected light in the image; and
generate the information based on the plurality of instances of the coordinate information, the information including boundary information indicating a boundary between the entry prohibited area and the travel area.

7. The travel map generation device according to claim 6,
wherein the processing circuitry is further configured to:
calculate first coordinate information from a first position that is a position, in the image, of reflected light produced by light of one color emitted from the light emission device;
calculate second coordinate information from a second position that is a position, in the image, of reflected light produced by light of another color emitted from the light emission device; and
determine a line segment connecting the first position and the second position as the boundary, based on the first coordinate information and the second coordinate information.

8. The travel map generation device according to claim 1,
wherein the processing circuitry is configured to:
correct the information based on an instruction from the user; and
correct the travel map based on the information corrected.

9. An autonomously traveling robot that travels autonomously over a predetermined floor, the autonomously traveling robot comprising:
a main body;
a travel mechanism that is disposed in the main body and that enables the main body to travel;
a position sensor that detects a position of an object in a vicinity of the main body and measures a positional relationship between the main body and the object; and
processing circuitry,
wherein the processing circuitry is configured to:
calculate a self position that is a position of the main body on the travel map, based on the travel map generated by the travel map generation device according to claim 1 and the positional relationship measured by the position sensor;
generate a travel plan on the predetermined floor based on the travel map and the self position; and
control the travel mechanism based on the travel plan.

10. The autonomously traveling robot according to claim 9, further comprising:
a cleaner that cleans a floor surface by executing at least one of wiping, sweeping, or suctioning debris,
wherein the processing circuitry is further configured to:
generate a cleaning plan on the predetermined floor; and
control the cleaner based on the cleaning plan.

11. A travel control system for controlling travel of an autonomously traveling robot that travels autonomously over a predetermined floor, the travel control system comprising:
a sensor that detects an object in a vicinity of the sensor and obtains a positional relationship between the sensor and the object; and
processing circuitry,
wherein the processing circuitry is configured to:
calculate, based on the positional relationship, a first self position indicating a self position on a floor map representing the predetermined floor;
obtain an image including reflected light produced by light emitted from a light emission device operated by a user;
generate, based on the first self position and the image, information indicating an entry prohibited area into which the autonomously traveling robot is prohibited from entering, or a travel area for the autonomously traveling robot, in the floor map;
generate a travel map for the autonomously traveling robot based on the information;
calculate a second self position indicating a self position on the travel map; and
generate a travel plan on the predetermined floor based on the travel map and the second self position.

12. The travel control system according to claim 11,
wherein the processing circuitry is further configured to:
accept an instruction from the user;
correct the information based on the instruction accepted; and
correct the travel map based on the information corrected.

13. A travel control method for controlling travel of an autonomously traveling robot that travels autonomously over a predetermined floor, the travel control method comprising:
detecting an object in a vicinity of the autonomously traveling robot and obtaining a positional relationship between the autonomously traveling robot and the object;
calculating a first self position indicating a self position on a floor map representing the predetermined floor;
obtaining an image including reflected light produced by light emitted from a light emission device operated by a user;
generating, based on the first self position calculated and the image obtained, information indicating an entry prohibited area into which the autonomously traveling robot is prohibited from entering, or a travel area for the autonomously traveling robot, in the floor map;
generating, based on the information generated, a travel map for the autonomously traveling robot, the entry prohibited area being set in the travel map;
calculating a second self position indicating a self position on the travel map generated; and
generating a travel plan on the predetermined floor based on the travel map and the second self position.

14. The travel control method according to claim 13, further comprising:
accepting an instruction from the user;
correcting the information based on the instruction accepted; and
correcting the travel map based on the information corrected.

15. A non-transitory computer-readable recording medium having recorded thereon a program for causing a computer to execute the travel control method for an autonomously traveling robot according to claim 13.
